(19) United States
(12) Patent Application Publication
(10) Pub. No.: US 2004/0107247 A1
(43) Pub. Date: Jun. 3, 2004

(54) Information processing system, server and Web address issuing method

(75) Inventor: Keiji Saito, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/720,467

(22) Filed: Nov. 25, 2003

(30) Foreign Application Priority Data
Nov. 28, 2002 (JP) 2002-345860

(51) Int. Cl. G06F 15/16

(52) U.S. Cl. 709/203; 709/218

(57) ABSTRACT

Upon receiving user information from a client system, a beacon server refers to a user database, acquires Web address information which is associated with the user information and is indicative of a most suitable Web page for a user, and transmits a URL beacon of the Web address information to the client system.

### CROSS-REFERENCE TO RELATED APPLICATIONS

This application is based upon and claims the benefit of priority from the prior Japanese Patent Application No. 2002-345860, filed Nov. 28, 2002, the entire contents of which are incorporated herein by reference.

### BACKGROUND OF THE INVENTION

1. Field of the Invention

The present invention relates to an information processing system having a server and a client, which perform wireless information exchange, and also to a server applicable to the system and a Web address issuing method applicable to the system.

2. Description of the Related Art

In a prior-art information processing system having a server and a client, which perform information exchange by radio, when Web address information is provided to the client from the server, the server always provides the same Web address information in response to a request from the client (Jpn. Pat. Appln. KOKAI Publication No. 2002-116968).

Thus, in the prior-art, there is a problem that Web address information to be wanted by users cannot be provided.

### BRIEF SUMMARY OF THE INVENTION

According to one embodiment the present invention, when an URL address is beacon-transmitted from a server to a client, the URL address that is beacon-transmitted is dynamically changed in accordance with the content of user information received from the client. Thereby, it is possible to provide a pointer for most suitable Web page information for each user who uses the client.

One embodiment of the present invention may provide an information processing system in which information exchange is performed between a server and a client, wherein the client includes means for transmitting user information to the server, and the server includes means for determining, based on the user information, Web address information to be provided to the client.

With the function of the present invention, Web address information to be wanted by users can be provided to each of a plurality of users who use a client. In addition, a URL of a most suitable Web page can be provided to each user. For example, a URL to be accessed may be changed between general non-specified users and specified users (e.g. shareholders, members of a shop, affiliate company members, or customers), or a different URL may be presented depending on the number of times of beacon reception by the user.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing the structure of an information processing system according to an embodiment of the present invention;

FIG. 2 is a flow chart illustrating a processing procedure in the embodiment; and

FIG. 3 illustrates a communication procedure in the embodiment.

### DETAILED DESCRIPTION OF THE INVENTION

An embodiment of the present invention will now be described with reference to the accompanying drawings.

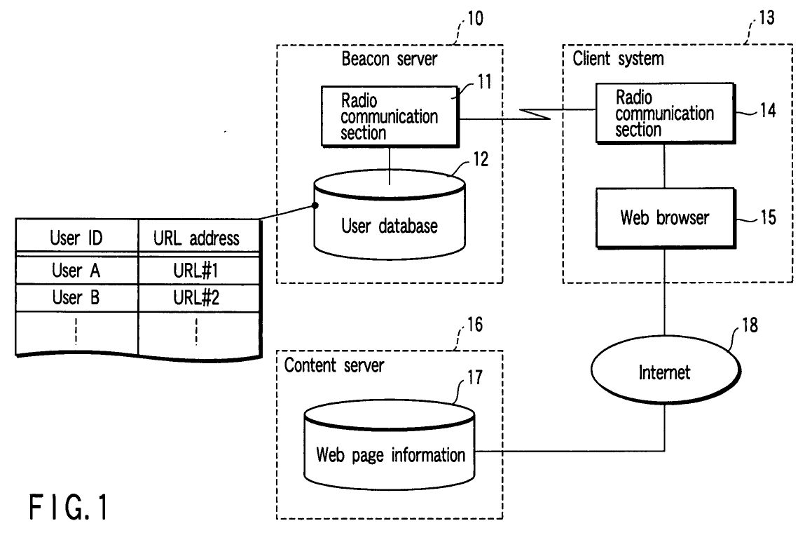

FIG. 1 is a block diagram showing the structure of an information processing system according to an embodiment of the present invention.

The information processing system shown in FIG. 1 is configured to include a beacon server 10 that transmits a URL beacon, a client system 13 that receives the URL beacon transmitted from the beacon server 10, and a content server 16 that stores Web page information.

The beacon server 10 includes a radio communication section 11 and a user database 12. The client system 13 includes a radio communication section 14 and a Web browser 15. The content server 16 stores Web page information 17 of a plurality of Web pages.

The beacon server 10 and client system 13 constitute a local area network (wireless LAN) using their own radio communication sections (11, 14). Data transmission/reception is thus performed between the beacon server 10 and client system 13.

The client system 13 connects to the Internet 18 using the Web browser 15. In this case, physical links and communication protocols used in the radio communication sections (11, 14) of the beacon server 10 and client system 13 are not limited and are freely chosen in the present invention. For example, a low-power wireless communication standard such as Bluetooth or an infrared communication standard such as IrDA may be used. Similarly, a physical link used by the Web browser 15 to access the Internet 18 is not limited and may be freely chosen in the present invention. For example, dial-up connection using a public switched telecommunication network or Internet access via a wireless LAN may be used.

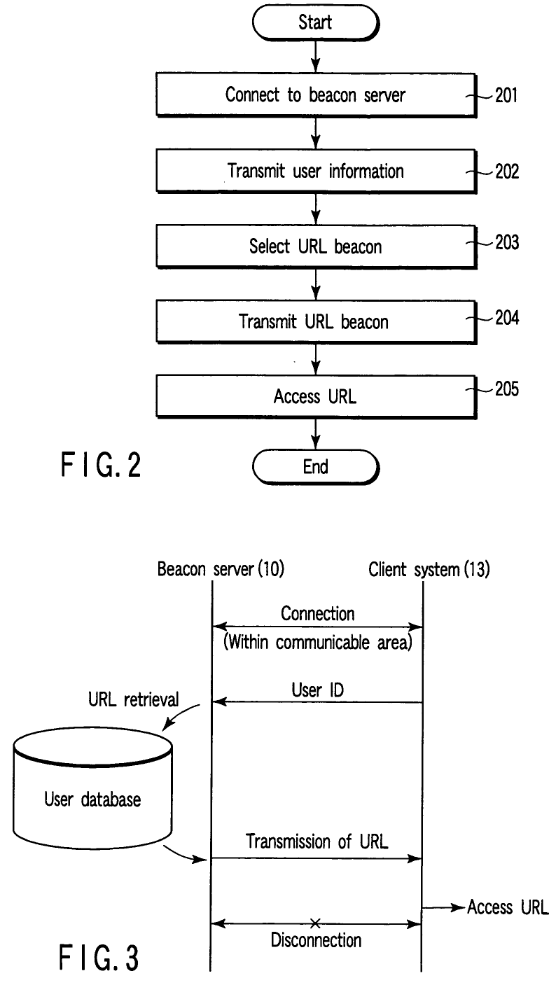

FIG. 2 is a flow chart illustrating a processing procedure in the embodiment, and FIG. 3 illustrates a communication procedure in the embodiment.

The operation of the embodiment of the invention will now be described with reference to the drawings.

The user database 12 provided in the beacon server 10 stores user information and Web address information with respect to a plurality of users who use the client system 13. In the user information, the users are classified into classes. The Web address information is provided for the respective classes. The user information and the Web address information are associated with respect to each class of users. The user information may be any one of the following: information on the users' ages, sexes, etc.; information on classified ages, sexes, etc. of users; unique ID information possessed by the radio communication section 14 of client system 13; user-specific information such as membership numbers assigned to users; information on users classified for specific purposes; information on classified users; and information on users' electronic business cards (V-cards). In this embodiment, as shown in FIG. 1, in the user database 12, user IDs for identifying users who use the client system 13 are associated with URLs of Web pages to be accessed.

The radio communication section 14 of the client system 13 establishes connection to the radio communication section 11 of the beacon server 10 in a communicable area of the beacon server 10. Thus, the client system 13 connects to the beacon server 10 (step 201 in FIG. 2).

Once the connection to the beacon server 10 is established, the client system 13 transmits the aforementioned user information to the beacon server 10 (step 202 in FIG. 2).

Upon receiving the user information from the client system 13, the beacon server 10 refers to the user database 12, acquires Web address information which is associated with the user information and is indicative of a most suitable Web page for the user, and transmits a URL beacon of the Web address information to the client system 13 (steps 203 and 204 in FIG. 2).

Upon receiving the URL beacon from the beacon server 10, the client system 13 delivers it to the Web browser 15. The Web browser 15 accesses the Web page information 17 in the content server 16 via the Internet 18 (step 205 in FIG. 2).

As has been described above, based on the user information received from the client system 13, the beacon server 10 refers to the user database 12 and acquires the Web address information. Then, the beacon server 10 transmits the URL beacon of the Web address information to the client, and presents the URL for accessing the Web page. Thereby, the user can always access the most suitable Web page.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing system, comprising:
a client section which includes a transmitting unit which transmits user information; and
a server section including a determining unit which determines, based on the user information, Web address information to be provided to the client section from the server section.

2. The information processing system according to claim 1, wherein
the determining unit includes a database that stores the user information of the client section and the Web address information to be provided to the client section, the user information and the Web address information being associated with each other, and
the server section refers to the database each time the server section receives the user information from the client section, acquires the Web address information associated with the received user information, and transmits the acquired Web address information to the client section.

3. The information processing system according to claim 1, wherein the transmitting unit forms a local area network with the server section, transmits the user information to the server section through the local area network, and acquires the Web address information from the server section.

4. The information processing system according to claim 1, wherein the client section further includes a Web browser that accesses a Web page via the Internet, and accesses the Web page using the Web address information received from the server section.

5. The information processing system according to claim 2, wherein the database stores user information identifying users who use the client section in associate with Web address information provided for each of the users.

6. The information processing system according to claim 2, wherein the database stores user information identifying the client in associate with Web address information provided for the client.

7. The information processing system according to claim 2, wherein the database stores user information formed by classifying users who use the client section into classes in associate with Web address information provided for each class.

8. The information processing system according to claim 3, wherein the server section transmits, over the local area network formed with the client section, a beacon in which a URL address is dynamically changed in accordance with the user information acquired from the client section.

9. The information processing system according to claim 1, wherein the client section communicates with the server section via a radio.

10. A server which performs communication with a client, comprising a database that stores user information of the client and Web address information to be provided to the client, the user information and the Web address information being associated with each other.

11. The server according to claim 10, wherein the server refers to the database each time the server receives the user information from the client, acquires the Web address information associated with the received user information, and transmits the acquired Web address information to the client.

12. The server according to claim 10, wherein the server communicates with the client via a radio.

13. A Web address issuing method for a system having a server and a client, which perform information exchange, comprising:
transmitting user information on users, who use the client, to the server from the client;
determining Web address information to be provided to the client, on the basis of the user information received from the client in the server; and
issuing the Web address information to the client from the server.

14. The Web address issuing method according to claim 13, wherein the server communicates with the client via a radio.

15. A Web address issuing method for a system having a server and a client, which perform information exchange,
wherein the server includes a database that stores user information and Web address information in an associated manner, the method comprising:
forming a local area network with the server and transmitting user information to the server by the client;
reading out of the database the Web address information in associated with the user information which is received from the client by the server; and
transmitting the Web address information to the client from the server.

16. The Web address issuing method according to claim 15, wherein the transmitting step transmits, over the local area network formed with the client, a beacon in which a URL address is dynamically changed in accordance with the user information acquired from the client.

17. The Web address issuing method according to claim 15, wherein the server communicates with the client via a radio.
